(19) United States
(12) Patent Application Publication
(10) Pub. No.: US 2008/0135392 A1
(43) Pub. Date: Jun. 12, 2008

(54) Illuminating Membrane Switch and Illuminating Keypad Using the Same

(76) Inventors: Huei-Pin Huang, Yangmei Township (TW); Chih-Ping Liang, Hsinchu City (TW)

Correspondence Address: GIBBONS P.C., ONE GATEWAY CENTER, NEWARK, NJ, 07102, US

(21) Appl. No.: 11/935,146

(22) Filed: Nov. 5, 2007

Related U.S. Application Data
(63) Continuation of application No. 11/245,647, filed on Oct. 7, 2005, now abandoned.

(30) Foreign Application Priority Data
Jun. 15, 2005 (TW) 094210002

(51) Int. Cl. H01H 13/705; H01H 13/52; H01H 13/83

(52) U.S. Cl. 200/5 A; 200/512; 200/310

(57) ABSTRACT

An illuminating membrane switch, including: an upper membrane sheet on which a plurality of wires are formed; a lower membrane sheet on which a plurality of wires are formed; and an electroluminescent device interposed between the upper membrane sheet and the lower membrane sheet, the electroluminescent device emitting rays through the upper membrane sheet and having a plurality of openings so as to allow the wires of the upper and lower membrane sheets to contact each other.

### RELATED APPLICATION

This application is a continuation of U.S. patent application Ser. No. 11/245,647, filed Oct. 7, 2005, entitled ILLUMINATING MEMBRANE SWITCH AND ILLUMINATING KEYPAD USING THE SAME, the entire disclosure of which is hereby incorporated by reference as if being set forth in its entirety herein.

### BACKGROUND OF THE INVENTION

1. Field of the Invention

The present invention relates to an illuminating membrane switch and an illuminating keypad or keyboard using the same, more particularly to a membrane switch capable of emitting rays to highlight alphanumeric symbols on keys and detecting any keystroke.

2. Description of Related Art

When working in a condition with low light or even no light, a user cannot see the alphanumeric symbols on the keys of a keyboard clearly, for example, when a notebook computer is used on planes, or when a keyboard attached to equipment is used in a lithography laboratory.

FIG. 1 is an upper view diagram of an illuminating keyboard disclosed is in U.S. Pat. No. 6,179,432. The keyboard 10 has a plurality of key caps 11 mounted on a housing 15 and is allowed to have finite downward displacement along its vertical direction. There is a symbol 12 printed on the surface of each of the key caps 11 to illustrate the function of the corresponding one, for example, numeric input keys 0-9, alphabetic input keys A-Z and function keys F1-F12. An electroluminescent device 13 is placed under the key caps 11, and is driven to illuminate by an AC source. Therefore, the 3.3V or 5V DC power supplied by a cable 14 needs to be converted into the specific AC power so as to meet the requirement of the electroluminescent device 13.

FIG. 2 is an exploded diagram of the illuminating keyboard in FIG. 1. The electroluminescent device 13 comprises a plurality of openings 131, each which is aligned with the corresponding key cap 11 above. Moreover, a driving circuit 133 converts the 3.3V or 5V DC power supplied by a cable 14 into the specific AC power so as to meet the specification of the electroluminescent device 13. An elastomer layer 21 made from rubber or silicone is placed beneath the electroluminescent device 13, and has a plurality of key actuators 211 whose positions correspond to the positions of the key caps 12. Because the key actuator 211 is very flexible, it can rapidly return to its original shape after a keystroke is released. When the key actuator 211 is deformed after the pressing of the key cap 12, a membrane switch 22 beneath the elastomer layer 21 is switched on, and meanwhile an input signal corresponding to the key cap 12 is transmitted to a host through the cable 14.

Because the electroluminescent device 13 is placed beneath the key cap 12, the structure of the key cap 12 needs to be redesigned to hold the thickness of the electroluminescent device 13. On the other hand, the deformed movement is still necessary for the key actuator 211, hence the total thickness of the key cap 12 is increased and the design of the keyboard structure becomes difficult.

### SUMMARY OF THE INVENTION

The primary objective of the present invention is to provide an illuminating membrane switch for a keyboard to detect any input of keystroke. The illuminating membrane switch also emits rays through key caps to light up the symbols printed on the surfaces of them when the keyboard is powered.

The second objective of the present invention is to provide an illuminating membrane switch acceptable for the structure of a conventional keyboard. The housing, key caps and key actuators of the conventional keyboard do not need to be redesigned.

In order to achieve the objective, the present invention discloses an illuminating membrane switch and illuminating keyboard using the same. The illuminating membrane switch comprises an upper membrane sheet, an electroluminescent device and a lower membrane sheet. The electroluminescent device is interposed between the upper membrane sheet and lower membrane sheet on which switch circuits are printed. In addition to emitting rays through the upper membrane sheet, the electroluminescent device has a plurality of openings allowing the switch circuits of them to contact each other. The keyboard utilizes the illuminating membrane switch to detect any input of keystroke. On the other hand, the keyboard can light up the symbols on the surfaces of key caps for a user to identify the function or alphabetic input of each key cap.

### BRIEF DESCRIPTION OF THE DRAWINGS

The invention will be described according to the appended drawings in which:

FIG. 1 is an upper view diagram of an illuminating keyboard disclosed in U.S. Pat. No. 6,179,432;

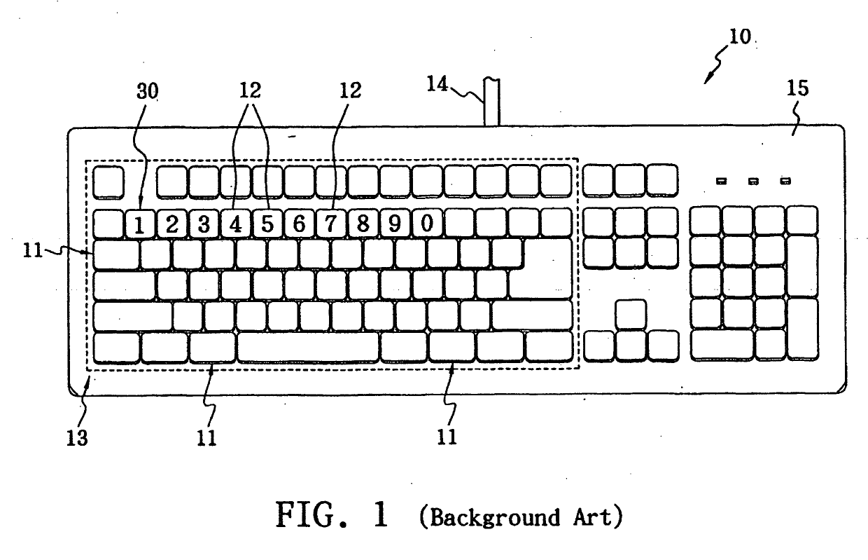

FIG. 2 is an exploded diagram of the illuminating keyboard in FIG. 1;

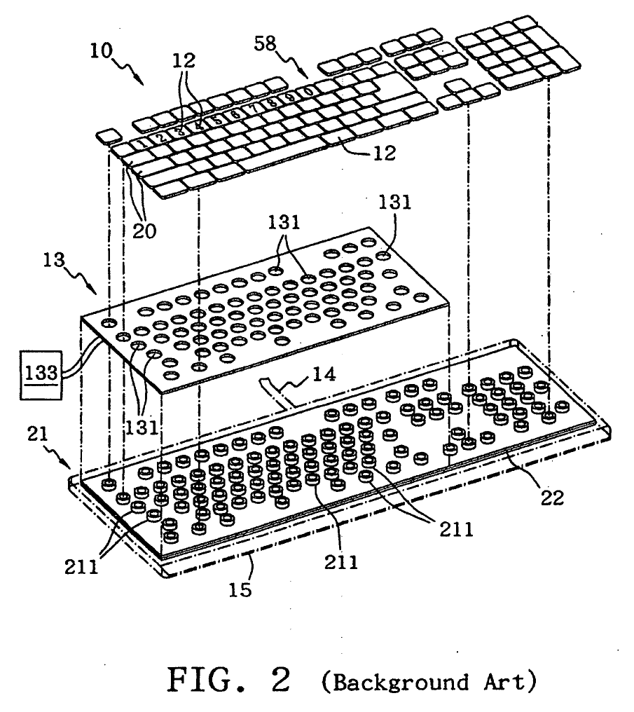

FIG. 3 is an exploded diagram of an illuminating key membrane and a keyboard or a keypad using the same in accordance with present invention;

FIG. 4 is a cross-sectional diagram illustrating the keyboard of a personal computer to which an illuminating membrane switch is applied in accordance with the present invention;

FIG. 5 is a cross-sectional diagram illustrating the keyboard of a notebook computer to which an illuminating membrane switch is applied in accordance with the present invention;

FIG. 6 is a cross-sectional diagram illustrating the keypads of a mobile phone to which an illuminating membrane switch is applied in accordance with the present invention;

FIG. 7 is an upper view diagram illustrating the metal cup in FIG. 6; and

FIG. 8 is a cross-sectional diagram illustrating the keypad of a controller to which an illuminating membrane switch is applied in accordance with the present invention.

### PREFERRED EMBODIMENT OF THE PRESENT INVENTION

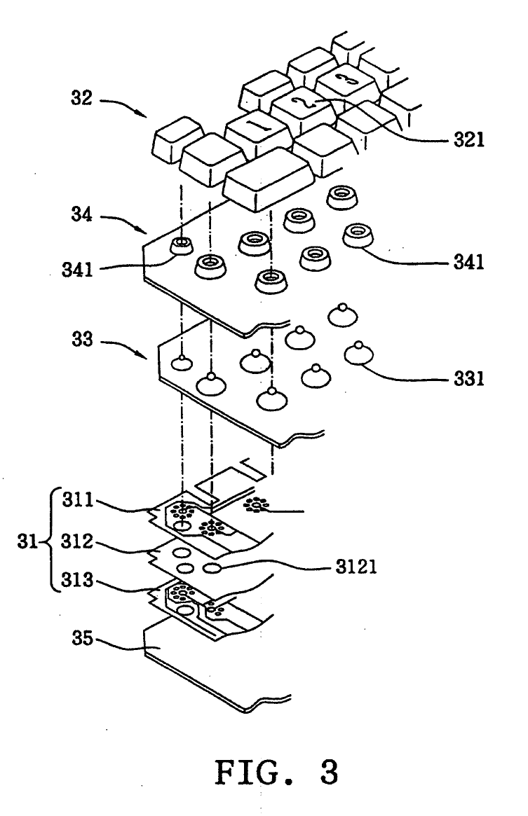

FIG. 3 is an exploded diagram of an illuminating key membrane and a keyboard or a keypad using the same in accordance with present invention. A plurality of key caps 32 are separately mounted on the seats 341 of an upper housing 34. Each of the key caps 32 is allowed to move down for a finite distance. Symbols are separately printed on the top surfaces of the key caps 32 to illustrate the functions or alphabet inputs of them. Moreover, an elastomer layer 33 made from silicone or rubber is placed under the seats 341, and has a plurality of key actuators 331 whose positions correspond to the positions of the key caps 32. Because the key actuator 331 is very flexible, it can rapidly return to its original shape after a keystroke is released.

When the key actuator 331 is deformed after the pressing of the key cap 32, an illuminating membrane switch 31 beneath it is switched on, and meanwhile an input signal corresponding to the key cap 32 is transmitted to a host through a cable (not shown). The illuminating membrane switch 31 comprises an upper membrane sheet 311, an electroluminescent device 312 and a lower membrane sheet 313. The electroluminescent device 312 not only separates the upper membrane sheet 311 from the lower membrane sheet 313, but also emits bright electroluminescent rays through the upper membrane sheet 311 to its exterior. The illuminating membrane switch 31 is placed on a metal plate 35, and is sandwiched in between the metal plate 35 and upper housing 34.

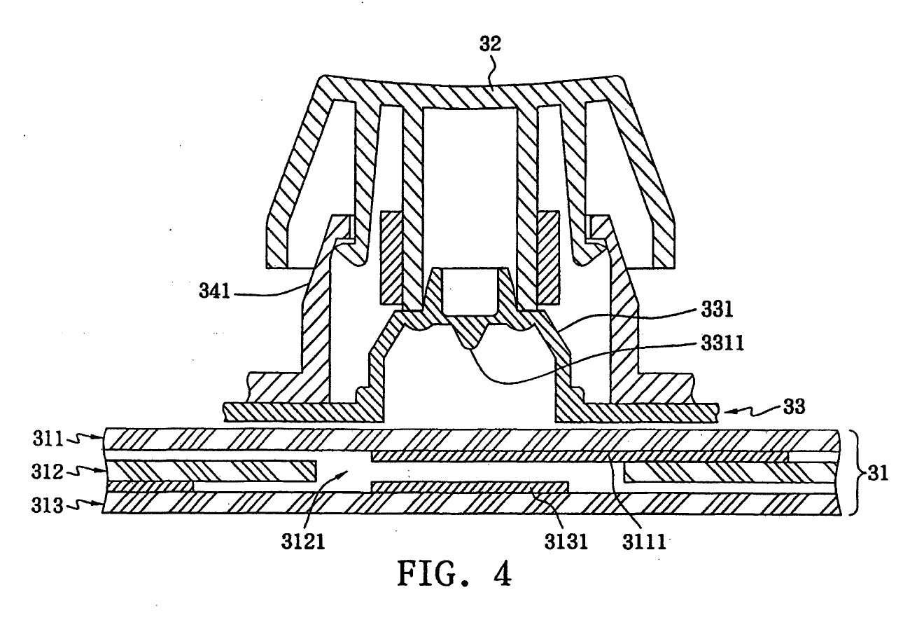

FIG. 4 is a cross-sectional diagram illustrating the keyboard of a personal computer to which an illuminating membrane switch is applied in accordance with the present invention. Because the inner of the key cap 32 and seat 341 are interlocked each other, it is difficult to separate the key cap 32 from the seat 341. The bottom of the key cap 32 is directly against the top surface of the key actuator 331. When the key cap 32 moves down after the pressing of a finger, the key actuator 331 is pressed to deform till the inner pressing portion 3311 forces the upper membrane sheet 311 and lower membrane sheet 313 to contact each other. The electroluminescent device 312 has a plurality of openings 3121 right under the corresponding key caps 32, and the upper membrane sheet 311 contacts the lower membrane sheet 313 through the opening 3121 after the downward pressing.

A plurality of wires 3111 and 3131 are respectively formed on two thin isolation substrates to have the upper membrane sheet 311 and lower membrane sheet 313. When the upper membrane sheet 311 reaches the lower membrane sheet 313, the wire 3111 and 3131 contact each other as an electrical loop to generate a corresponding input signal. Generally, the wire pattern is formed by printing silver pastes on the isolation substrate, and the edges of the upper membrane sheet 311 and lower membrane sheet 313 are sealed together to prevent the silver paste from oxidation.

For the sake of illuminating the symbols 321 on the key caps 32 by means of the rays from the electroluminescent device 312, transparent or translucent silicone is suitable for as the elastomer layer 33. Furthermore, the key caps 32 and upper housing 34 are preferably made from transparent plastic or acrylic material.

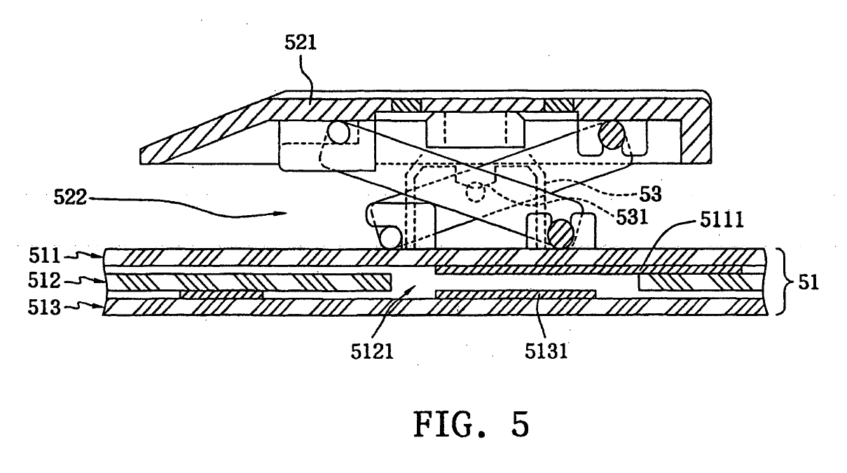

FIG. 5 is a cross-sectional diagram illustrating the keyboard of a notebook computer to which an illuminating membrane switch is applied in accordance with the present invention. The key cap 521 is fixed to a link mechanism 522 (like a so-called pantograph) in which a rubber spring 53 is placed. An illuminating membrane switch 51 is placed under the rubber spring 53. When the key cap 521 is moved down by the pressing of a finger, the rubber spring 53 is deformed till the inner pressing portion 511 forces the upper membrane sheet 511 and lower membrane sheet 513 to contact each other. The electroluminescent device 512 has a plurality of openings 5121 right under the corresponding key caps 32, and the upper membrane sheet 511 contacts the lower membrane sheet 513 through the opening 5121 after the downward pressing. That is, the wires 5111 and 5131 on them contact each other as an electrical loop to generate a corresponding input signal.

Similarly, for the sake of illuminating the symbols 512 on the key caps 521 by means of the rays from the electroluminescent device 512, transparent or translucent silicone is suitable for as the elastomer layer 53. Furthermore, the key caps 521 and link mechanism 522 are preferably made from transparent plastic or acrylic material.

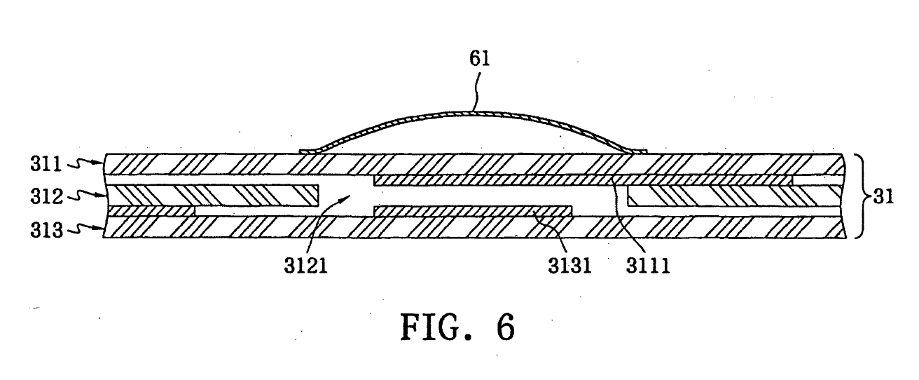

FIG. 6 is a cross-sectional diagram illustrating the keypad of a mobile phone to which an illuminating membrane switch is applied in accordance with the present invention. When a metal cup 61 is pressed, the illuminating membrane switch 31 beneath it is switched on, and meanwhile the upper membrane sheet 311 and lower membrane sheet 313 contact each other. The metal cup 61 is glued to the surface of the upper membrane sheet 311.

The illuminating membrane switch 31 is not only applied to the keyboards of the personal computers, but also is applied to keypads such as a remote controller, a data entry panel and a control faceplate.

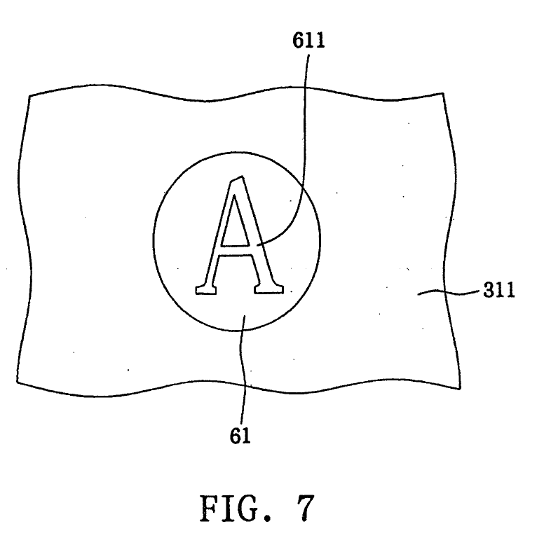

Furthermore, a symbol 611 is printed on or hollowed out the metal cup 61, as shown in FIG. 7. The metal cup 61 can be replaced with a resilient shell such as a transparent plastic shell.

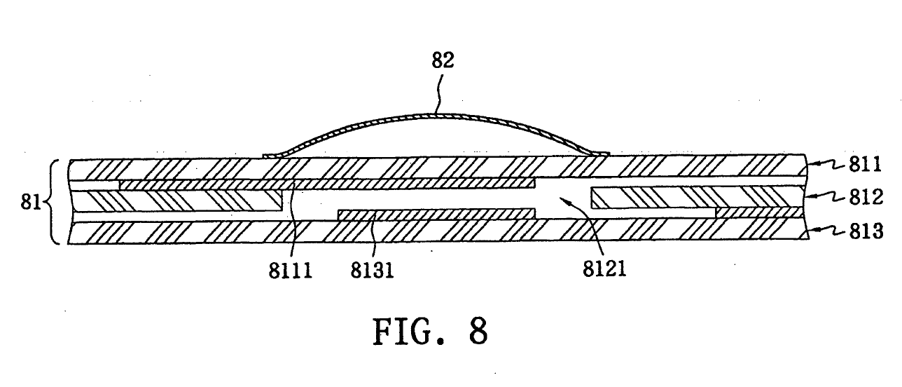

FIG. 8 is a cross-sectional diagram illustrating the keypad of a controller to which an illuminating membrane switch is applied in accordance with the present invention. In comparison with FIG. 6, the illuminating membrane switches 81 and 31 are different from each other. The illuminating membrane switch 81 comprises an electroluminescent device 811, a spacer 812 and a circuit board 813. The spacer 812 just separates the electroluminescent device 811 from the circuit board 813. The electroluminescent device 811 emits bright electroluminescent rays directly through its upper surface to the side toward a transparent plastic shell 82. The circuit board 813 can be a flexure print circuit board or a multilayer print circuit board integrated with some active electronic devices or passive electronic devices.

When the surface of the transparent plastic shell 82 is sagged after the sufficient pressing of a finger, the electroluminescent device 811 and circuit board 813 are forced to contact each other through an opening 8121 of the spacer 812. If the electroluminescent device 811 reaches the circuit board 813, a wire 8111 formed on the electroluminescent device 811 and a wire 8131 formed on the circuit board 813 contact each other as an electrical loop to generate a corresponding input signal.

The above-described embodiments of the present invention are intended to be illustrative only. Numerous alternative embodiments may be devised by persons skilled in the art without departing from the scope of the following claims.

What is claimed is:

1. An illuminating membrane switch, comprising:
an upper membrane sheet on which a plurality of wires are formed;
a lower membrane sheet on which a plurality of wires are formed; and
an electroluminescent device interposed between the upper membrane sheet and the lower membrane sheet, the electroluminescent device emitting rays through the upper membrane sheet and having a plurality of openings so as to allow the wires of the upper and lower membrane sheets to contact each other.

2. The illuminating membrane switch of claim 1 wherein each membrane sheet comprises an isolation material.

3. The illuminating membrane switch of claim 1 wherein the wires are formed by printing silver paste.

4. An illuminating keypad, comprising:
an illuminating membrane switch including:
an upper membrane sheet on which a plurality of wires are formed;
a lower membrane sheet on which a plurality of wires are formed; and
an electroluminescent device interposed between the upper membrane sheet and lower membrane sheet, the electroluminescent device emitting rays through the upper membrane sheet and having a plurality of openings so as to allow the wires of the upper and lower membrane sheets to contact each other; and
a plurality of key caps respectively placed right above the openings of the electroluminescent device;
wherein, the key caps move down to press the wires of the upper and lower membrane sheets to contact each other.

5. The illuminating keypad of claim 4, further comprising an elastomer layer interposed between the key caps and illuminating membrane switch and having a plurality of key actuators, wherein the key actuator is deformed till it contacts the upper membrane sheet after the key cap is pressed.

6. The illuminating keypad of claim 5, further comprising a link mechanism between the key cap and the illuminating membrane switch, the link mechanism limiting the key cap to move a finite distance along a vertical direction of the illuminating membrane switch.

7. The illuminating keypad of claim 5, further comprising an upper housing having a plurality of seats, which limit the key cap to move a finite distance along a vertical direction of the illuminating membrane switch.

8. The illuminating keypad of claim 4, further comprising a metal plate placed beneath the illuminating membrane switch.

9. The illuminating keypad of claim 4, wherein the key caps are metal cups or transparent plastic shells.

10. The illuminating keypad of claim 9, further comprising a symbol printed on or hollowed out the key cap.
